(19) United States
(12) Patent Application Publication
(10) Pub. No.: US 2025/0110729 A1
(43) Pub. Date: Apr. 3, 2025

(54) CONFIGURING APPLICATION FEATURES IN A CLOUD-BASED ENVIRONMENT

(71) Applicant: Google LLC, Mountain View, CA (US)

(72) Inventor: Shu Lu, Mosman (AU)

(21) Appl. No.: 18/478,045

(22) Filed: Sep. 29, 2023

(51) Int. Cl. G06F 8/71

(52) U.S. Cl. CPC G06F 8/71

(57) ABSTRACT

A request for configuring an application feature for an instance of an application provided by a platform is received from a client device of a user. An electronic document associated with the application feature is identified from a set of electronic documents. Each of the set of electronic documents is associated with a respective application feature provided by the platform and includes elements that enable users to configure settings pertaining to the respective application feature. The electronic document is provided for presentation to the user. Configuration data associated with settings pertaining to the application feature is obtained based on user interaction with elements of the electronic document. The application feature is configured for the application instance based on the electronic document and the configuration data. The user is provided with access to the configured application feature in accordance with the request.

### TECHNICAL FIELD

Aspects and implementation of the present disclosure relate to configuring application features in a cloud-based environment.

### BACKGROUND

A platform (e.g., a cloud-based platform) can provide users with access to applications via a cloud-based system. The platform can provide client devices associated with the user with access to one or more applications (e.g., to assist the organization in performing its operations). The effective configuration and customization of application features in a cloud-based environment remains a challenge. As users increasingly adopt cloud-based solutions, the demand for efficient and user-friendly techniques to tailor applications to specific user requirements increases.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a system and method are disclosed for configuring application features in a cloud-based environment. In an implementation, a method includes receiving a request from a client device of a user of a platform for configuring of an application feature, of a set of application features, for an instance of an application provided by the platform. The application instance is executing using at least the client device. The method further includes identifying, from a set of electronic documents, an electronic document that is associated with the application feature of the request. Each of the set of electronic documents is associated with a respective application feature of the plurality of application features. Each of the plurality of electronic documents include elements that enable users to configure settings pertaining to a respective application feature. The method further includes providing the electronic document to the user via a user interface (UI) of the client device. The method further includes obtaining configuration data associated with one or more settings pertaining to the application feature based on a user interaction with one or more elements of the electronic document via the UI. The method further includes configuring the application feature for the application instance based on the electronic document and the obtained configuration data. The method further includes providing the user with access to the configured application feature for the application instance via the client device, in accordance with the request.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to specific aspects or implementations, but are for explanation and understanding only.

FIG. 1 illustrates an example system architecture, in accordance with implementations of the present disclosure.

FIG. 2 is a block diagram illustrating a platform and a configuration manager, in accordance with an implementation of the disclosure.

FIG. 3 is a flow diagram illustrating an example method for configuring application features in a cloud-based environment, in accordance with an implementation of the disclosure.

FIGS. 4A-4B illustrate examples of configuring application features in a cloud-based environment, in accordance with an implementation of the disclosure.

FIGS. 5A-5B illustrate examples of generating a configuration file for an application feature in a cloud-based environment, in accordance with an implementation of the disclosure.

FIG. 6 is a block diagram illustrating one implementation of a computer system, in accordance with an implementation of the disclosure.

### DETAILED DESCRIPTION OF THE DRAWINGS

Aspects of the present disclosure generally relate to configuring application features in a cloud-based environment. A cloud-based environment can employ a network of computing systems (e.g., remote servers) that store, manage, and/or process data to deliver hosted services. Such services can include Infrastructure-as-a-Service (IaaS), Platform-as-a-Service (PaaS), Software-as-a-Service (SaaS), and so forth. In some instances, the hosted services can be provided via or can otherwise correspond to applications that are accessible to client devices connected to the computing systems (e.g., via a network). Such applications are referred to as cloud-based applications and can be hosted and operated by the computing resources of the cloud-based environment.

In some instances, a platform (e.g., a cloud-based platform) can provide users with access to one or more cloud-based applications. In an illustrative example, a user (or group of users) can be associated with an entity or organization. The cloud-based application can be associated with one or more operations or functionalities pertaining to the entity or organization. The platform can provide client devices of the entity or organization (e.g., associated with the users) with access to the cloud-based application. In some instances, multiple different users (e.g., each associated with a different organization or entity) may access instances of the cloud-based application. An application instance refers to a set of processes for an application that are executing using computing resources (e.g., a client device, allocated remote computing resources, etc.) associated with a particular user or user account. Each instance of an application can provide the same or similar functionality, but can be isolated from other application instances.

A platform can offer to users one or more features for a cloud-based application, which can provide improved or additional functionality of the cloud-based application (e.g., over base features of the application). Examples of cloud-based application features may include, but are not limited to, notification or messaging-based features (e.g., electronic mail (email)-based features), storage-based features, data sharing-based features data collection-based features, data visualization-based features, user workflow-based features, customer relationship management (CRM)-based features, accounting or auditing-based features, and so forth. The platform can provide users with access to a cloud-based application feature (also referred to as a cloud-based feature or an application feature herein) via an application instance for the cloud-based application provided to client device(s) of the users. In some instances, the platform can provide multiple different users with access to the same cloud-based feature, though configuration of the cloud-based feature can be distinct or customized for each respective user.

As cloud-based applications have proliferated, more and more users are requesting customized application features. A customized application feature can be composed or otherwise created using a base configuration framework (e.g., source code, etc.) and user-specific configuration data. The base configuration framework serves as a blueprint for the application feature, outlining the core functionalities, processes, user interfaces, etc. of the feature. The core functionalities, processes, etc. for an application feature can be supported by one or more resources (e.g., provided by the platform or by other platforms and/or computing systems of the cloud-based environment). The resources can include computing resources (e.g., network-based resources, storage-based resources, etc.) and/or other types of resources (e.g., functionality of another application provided by the platform or by another platform). The user-specific configuration data can include, but is not limited to, user preferences, user roles, access permissions, interface layouts, data sources, process rules, automation logic, etc.

In some instances, updates or changes can be made to the base configuration framework for an application feature and/or resources that support the application feature. For example, source code for the base configuration framework can be programed according to a particular programming language (e.g., Python, etc.). An updated version of the programming language can be released, and compilers for the programming language can be modified to accommodate the updated version of the programming language. The modified compilers may no longer support source code that is programmed according to the prior version of the programming language, and accordingly the platform cannot provide users with access to the application feature unless the source code is updated to reflect the updated version of the programming language. In another example, an application feature can access and/or modify data of another application (e.g., hosted by another platform) via an application programming interface (API). The other platform that hosts the other application may update or otherwise modify the API for the application. The application feature may not access and/or modify the data of the other application until source code (or other configuration files) for the application feature is updated in accordance with the update/modification to the API.

In conventional systems, functionalities of an application feature and underlying resources are individually configured for each customized feature for users of a cloud-based application. For example, during initialization and installation of an application feature for an application instance of a user, source code for the application feature can be modified based on user-specific configuration data (e.g., provided or otherwise determined for the user) and transmitted to a client device associated with the user and/or stored at a region of memory (e.g., a network-attached storage) associated with the user. When the base framework for the application feature and/or the resources that support functionalities of the application feature are updated (e.g., by the platform and/or another platform), the base configuration framework and/or underlying resource for the feature is accordingly updated and the application feature is re-initialized and re-installed for the application instance (e.g., or the application feature may be inaccessible to the user). An application feature can be updated a significant number of times during a time period (e.g., days, weeks, months, etc.). Accordingly, a significant number of computing resources (e.g., processing cycles, memory space, etc.) can be consumed to update the base framework and/or underlying resources for each update. In some instances, the update to the base framework and/or the underlying resources may cause the application feature to be inaccessible by the user, which can impact a performance (e.g., efficiency, throughput, latency, etc.) of the user's workflow and/or a performance of the overall system.

Further, an update to the base framework and/or underlying resources of an application feature can require updated user-specific configuration data to reconfigure the application feature following the update. An application feature can involve multiple different resources, access to which by the user is individually authorized (e.g., based on an authentication process). A user may provide a significant amount of data and/or provide sensitive data to the platform according to the authentication process to obtain access to each resource. Such user-provided data is referred to as user authentication data herein and can be included as part of or may be separate from the user-specific configuration data. It can be difficult for a user to track, maintain and/or store the user-specific configuration data and/or user authentication data for obtaining access to the application feature. Further, each update to the application feature can involve a change or modification of the authentication process and the amount/type of data that is provided by the user to obtain access to the resource(s). Such changes or modifications can further increase the amount of data that is to be tracked, maintained, and/or stored by the user, which can consume a significant amount of computing resources (e.g., processing cycles, memory space, etc.) at client devices of the users and/or at the platform.

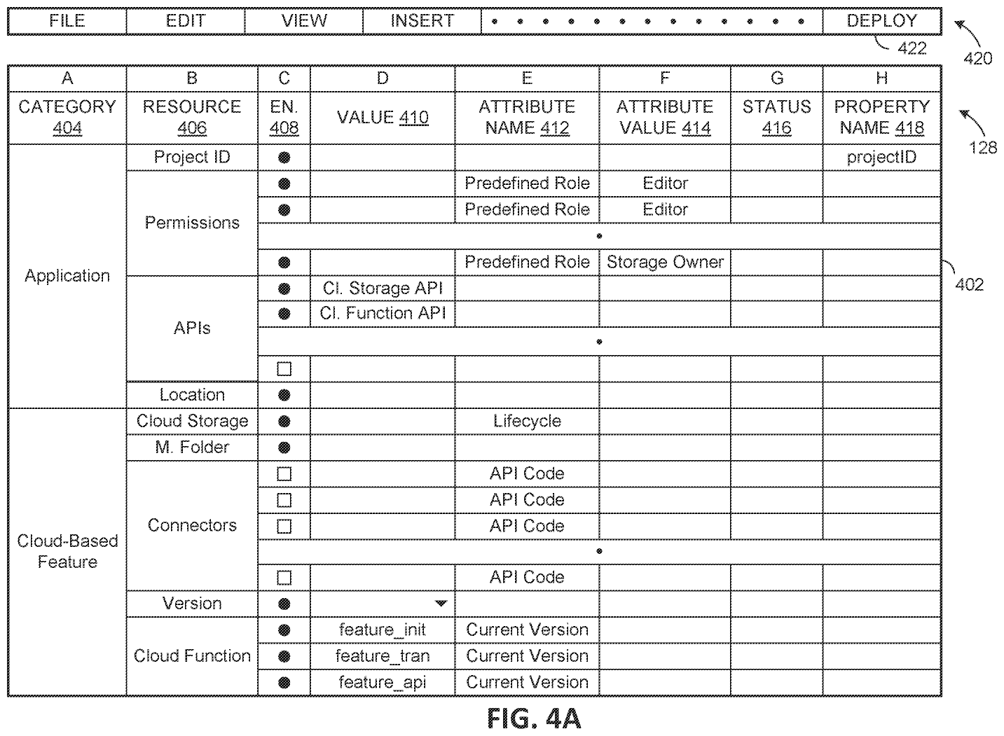

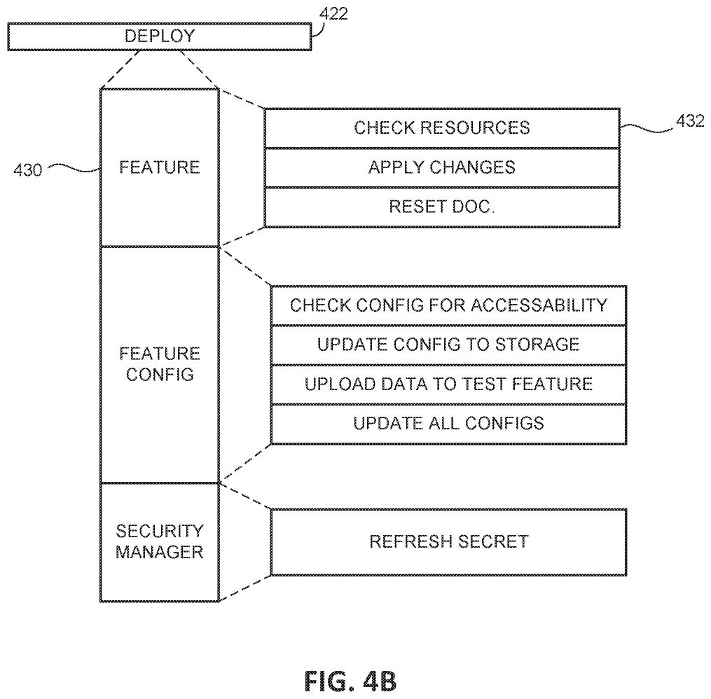

Aspects and implementations of the present disclosure address the above and other deficiencies by providing techniques for configuring application features in a cloud-based environment based on configuration data provided by a user via an electronic document (e.g., a spreadsheet document). A platform can maintain electronic documents that each correspond to a distinct cloud-based feature for a cloud-based application provided by the platform. In some embodiments, the electronic document can include or otherwise correspond to a form that includes elements pertaining to functionalities or processes of the application feature. In some embodiments, the elements can pertain to underlying resources of the application feature, such as resources provided by the platform and/or resources provided by other platforms or computing systems in the cloud-based environment. In an illustrative example, the electronic document can include one or more elements pertaining to a database that is accessed by the user and/or the platform in accordance with a functionality of the application feature. In another illustrative example, the electronic document can include one or more elements pertaining to an API that enables the cloud-based application to interface with another cloud-based application (e.g., provided by the platform or by another platform). An example electronic document is illustrated by FIG. 4A.

Each element of the electronic document can be mapped to or otherwise associated with one or more operations for the application feature. In some embodiments, the one or more operations can be included in or otherwise referenced by source code for the application feature. For example, the elements can be mapped to or can otherwise be associated with a portion of the source code that relates to creating a database, updating the database, and/or otherwise providing a user with access to the database. In another example, the elements pertaining to the API can be mapped to or otherwise be associated with a portion of the source code that relates to initializing and facilitating a connection between the cloud-based application and the other cloud-based application via the API. In some embodiments, the one or more operations mapped to and/or associated with an element can include placeholder values that represent a reference to user-specific configuration data. For example, the portions of the source code pertaining to the database can include one or more placeholder values that represent a reference to a particular database of a user accessing an application feature. The platform can obtain the user-specific configuration data that is to replace the placeholder values of the source code based on a user interaction with the elements of the electronic document, as described below.

In some embodiments, the platform can provide a user with access to an instance of a cloud-based application. The platform can receive a request from a client device of a user for configuring of a cloud-based feature for the application instance (e.g., prior to or after providing access to the application instance). The platform can identify an electronic document that is associated with the cloud-based feature of the request. As indicated above, the identified electronic document can include elements that enable the user to configure settings pertaining to the cloud-based feature. In some embodiments, the settings can correspond to each functionality or process of the application feature, as described above. In other or similar embodiments, the settings can pertain to an underlying resource of the application feature, as described above.

Responsive to identifying the electronic document, the platform can provide the electronic document to the user via a user interface (UI) of the client device (e.g., as depicted by FIG. 4A). The user can configure settings pertaining to the cloud-based feature by engaging with one or more elements of the electronic document. In accordance with at least one previous illustrative example, the electronic document can include one or more elements pertaining to a database. The user can engage with the one or more elements to provide an indication of a name or identifier for the database. Further details regarding the user configured settings pertaining to the cloud-based feature are provided herein. Data provided via the user selection/engagement with the one or more elements of the electronic document can correspond to user-specific configuration data (also referred to simply as configuration data) for the application feature.

The platform can obtain the provided configuration data from the client device (e.g., via a network) and can configure the cloud-based feature for the application instance based on the electronic document and the configuration data. As indicated above, each element of the electronic document can be mapped to and/or be associated with operation(s) for enabling the cloud-based feature. In some embodiments, the platform can modify the operation(s) (e.g., by modifying the source code including the operations) to replace a placeholder value of the source code with a portion of the configuration data provided by the user. In accordance with the previous illustrative example, the source code pertaining to the database can include one or more placeholder values that reference a particular database that is to be accessed by a user accessing the application feature. The platform can update the source code to replace the one or more placeholder values with the name or identifier for the database provided by the user with the configuration data. In some embodiments, the platform can create a configuration file that corresponds to the application instance of the user. The configuration file can include a copy of the source code with the configuration data, as described above. Rather than updating the source code of the electronic document, the platform can replace placeholder values of the source code with corresponding configuration data in the configuration file, as described above.

The platform can configure the cloud-based feature for the application instance and provide the user with access to the configured cloud-based feature via the client device, in accordance with the request. In some embodiments, the platform (or a processing device of the platform) can execute the configuration file to enable the cloud-based feature. The platform can provide an output of the executed configuration file to the client device (e.g., via a network) to provide the user with access to the cloud-based feature, in such embodiments. In other or similar embodiments, the platform can provide the configuration file to the client device and the client device can execute the configuration file to provide the user with access to the cloud-based feature.

In some embodiments, base framework and/or an underlying resource for the cloud-base feature can be updated (e.g., by the platform, by another platform or computing system of the cloud-based environment, etc.). In an illustrative example, the source code can be programmed according to a particular programming language (e.g., Python) that is updated to a newer version. The platform (or a developer of the platform) can update the source code mapped to each element of the electronic document according to the update and can regenerate the configuration file for the user's configuration based on the updated electronic document and the user-provided configuration data. In some embodiments, the platform can execute the regenerated configuration file to provide the user with access to the feature and/or can transmit the regenerated configuration file to the client device for execution. Accordingly, the platform can provide continuous access to the cloud-based feature without interruption or re-configuration by the user.

Aspects of the present disclosure address the above mentioned deficiencies by providing techniques that enable a platform to maintain an electronic document that can be used to generate configuration files for a user configuration of a cloud-based application feature. As described above, the electronic document can include elements that are mapped to or otherwise associated with operations associated with a base framework of the application feature and/or underlying resources for the feature. A user can interact with the elements to provide configuration data for the application feature, which is used to generate a configuration file for the user configuration of the cloud-based feature. If updates or changes are made to the cloud-based feature (or the underlying resources of the cloud-based feature), the updates or changes can be reflected, e.g., in the source code mapped to the elements of the electronic document, and an updated configuration file can be generated for the user configuration. The updated configuration file can be used to provide the user with continuous access to the application feature, without reinitializing or reinstalling the application feature and/or reinitializing the underlying resources that enable the user's application instance. As embodiments of the present disclosure prevent the reinitialization and reinstallation of the application feature and/or underlying resources for each update made to the application feature, fewer computing resources are consumed (e.g., by the platform, by the overall computing system, etc.) to provide the user with continuous access to the application instance, and such computing resources are made available to other processes, which increases an overall efficiency and decreases an overall latency of the computing environment.

Further, as indicated above, the electronic document can correspond to a form that includes elements that enables a user to easily provide configuration data for a customized configuration of the application feature. The elements of the electronic document can easily and clearly indicate to a user what information or data is to be provided to create the customized configuration, which can simplify the configuration process for the user. The platform can store the user-provided configuration data (e.g., in a data store), which can be used to generate an updated configuration file, as described above. As the platform stores the configuration data used to generate the updated configuration file, the user does not have to provide the configuration data to the platform for each update to the application feature, which relieves the user from tracking, maintaining, and/or storing the configuration data (e.g., via the client device).

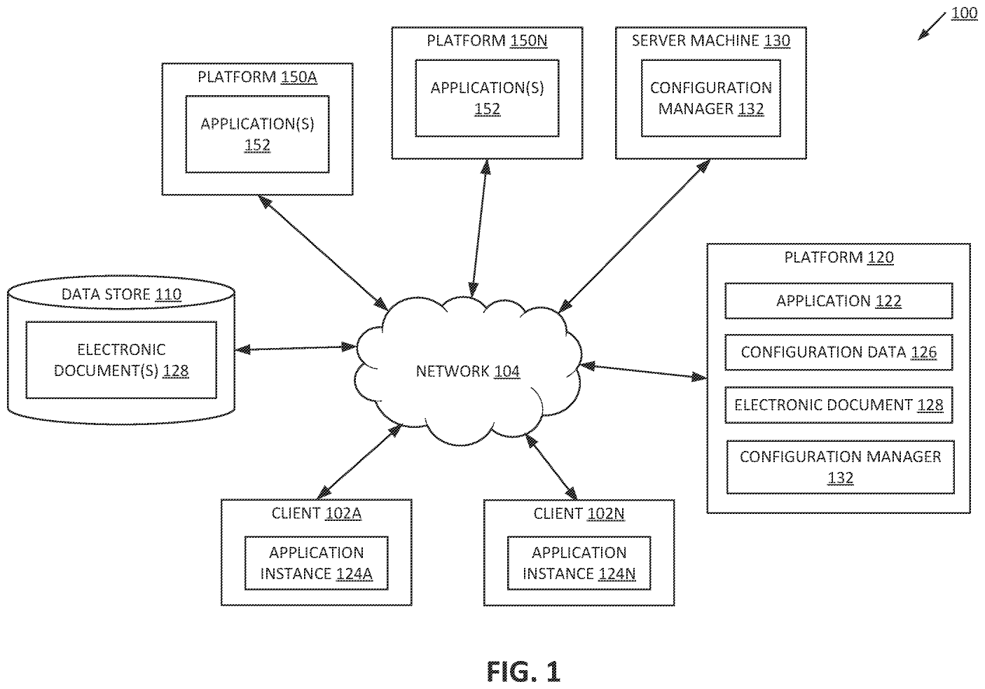

FIG. 1 illustrates an example system architecture 100, in accordance with implementations of the present disclosure. The system architecture 100 (also referred to as “system” herein) includes client devices 102A-N, a data store 110, a platform 120 (e.g., a cloud-based application platform), and/or one or more server machines 130, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof. In some embodiments, system architecture 100 can correspond to or be included in a cloud-based environment. As illustrated in FIG. 1, system 100 can include or can be connected to one or more additional platforms 150 (e.g., platform 150A-150N), which can be hosted or otherwise associated with the same or a different entity that hosts or is associated with platform 120.

The client devices 102A-N (collectively and individually referred to as client device(s) 102 or client device 102 herein) may each include computing devices such as personal computers (PCs), laptops, mobile phones, smart phones, tablet computers, netbook computers, network-connected televisions, etc. In some implementations, client devices 102A-N may also be referred to as “user devices.” Each client device may include a content viewer. In some implementations, a content viewer may be an application that provides a user interface (UI) for users to view or upload content, such as images, video items, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital images, electronic books, etc.).

In some embodiments, platform 120 can provide client device 102 access to an application 122 (e.g., a cloud-based application). A cloud-based application refers to a program or service that operates over a network (e.g., network 104) utilizing remote computing resources. In some embodiments, platform 120 can provide client device 102 with access to an instance of application 122 (e.g., application instance 124). An application instance refers to a set of processes for an application that are executing using computing resources (e.g., client device 102) associated with a particular user. Each instance 124 of application 122 can provide the same or similar functionality, but can be isolated from other application instances 124. As illustrated in FIG. 1, client device 102A can access the functionality and/or features of application 122 via application instance 124A and client device 102N can access the functionality and/or features of application 122 via application instance 124N.

The features of application 122 that are accessible to a client device 102 can be defined by configuration data 126. Configuration data 126 (also referred to as configuration 126 herein) refers to settings or constraints for a user's access of application instance 124. Configuration data 126 can be provided to platform 120 by a user (e.g., via one or more client devices 102 associated with the tenant) or by another entity of system 100 (e.g., a developer or operator of system 100, etc.). In additional or alternative embodiments, configuration data 126 can be determined or updated based on a behavior or performance of application instance 124 running on a client device 102. Configuration data 126 can include, in some embodiments, parameters or settings related to tenant preferences, access controls, data storage options, custom workflows, integration settings, and so forth.

In some embodiments, platform 120 can offer to users one or more features for application 122, which provide improved or additional functionality of the application 122 (e.g., over base features of application 122). In an illustrative example, application 122 can include features or functionalities that enables a user to track engagement of other users with one or more objects or services of the user. An application feature can for the application 122 can involve importing or exporting data associated with user engagement between application 122 and other applications (e.g., application 152 of platform 150) of or connected to system 100. Examples of an application feature may include, by are not limited to, notification or messaging-based features (e.g., electronic mail (email)-based features), storage-based features, data sharing-based features, data collection-based features, data visualization-based features, user workflow-based features, customer relationship management (CRM)-based features, accounting or auditing-based features, and so forth.

In some examples, a notification or messaging-based feature can enable users of application 122 to communicate (e.g., electronically) with other users of platform 120 and/or with users of other applications and/or other platforms 150. In some examples, a storage-based feature enables users to store data associated with application 122 and/or application instance(s) 124 at data store 110 or another memory of or connected to system 100. In some examples, a data-sharing based feature enables an application instance 124 to share data with other application instances 124, with platform 120, and/or with applications 152 (or application instances) of platform 150. In some examples, a data collection-based feature enables application instance 124 and/or application 122 to collect and/or organize data. In some examples, a data visualization-based feature enables users to access visualizations (e.g., charts, graphics, etc.) representing data received or otherwise collected by application instance 124 and/or application 122. In some examples, a user workflow-based feature enables a user to define and/or manage workflows pertaining to tasks or processes performed via the application instance 124 and/or application 122. In some examples, a CRM-based feature enables a user to track and/or maintain relationships or connections with other users (e.g., customers). In some examples, an accounting or auditing-based feature enables application instance 124 and/or application 122 to perform accounting tasks and/or auditing tasks based on data associated with a user's access of application instance 124 and/or application 122. As noted above, such examples of application features are provided for the purposes of example and illustration. An application feature can involve any type of functionality pertaining to an application 122 or application instance 124.

An application feature for application 122 (and/or application instance 124) can be configured based on configuration data 126. In some embodiments, platform 120 can provide a user with access to an application feature by executing one or more configuration files that include operations pertaining to the application feature. In other or similar embodiments, platform 120 can provide a user with access to the application feature by providing the one or more configuration files to a client device 102 (e.g., that is running an instance 124 of application 122). The client device 102 can execute the configuration files, as described herein. Further details regarding configuration files for application features and generation of the configuration files are described herein.

As illustrated in FIG. 1, platform 120 can include a configuration manager 132 that is configured to manage configuration data 126 for each application feature of application 122. Configuration manager 132 can, in some embodiments, generate a configuration file based on the configuration data 126. In some embodiments, platform 120 may receive a request for configuring of an application feature for an application instance 124 running via a client device 102. Platform 120 can maintain one or more electronic documents 128 that each correspond to a respective application feature of application 122. Each electronic document 128 can include one or more elements that pertain to functionalities or processes of the application feature and/or underlying resources that support the functionalities or processes of the application feature. In some embodiments, an electronic document 128 can include or otherwise correspond to a form that organizes the settings in a way that is easy for users (e.g., of client device 102A) to access and/or understand. An example electronic document 128 is illustrated by FIG. 4A below.

Each element of the electronic document 128 can be mapped to or otherwise associated with one or more operations for the application feature. In some embodiments, the one or more operations can be included in or otherwise referenced by source code for the application feature. Platform 120 can provide an electronic document 128 to client device 102 in response to a request for configuring of the application feature. Client device 102 can provide a user with access to the electronic document 128 via a user interface (UI) of client device 102. The user can interact with the elements of the electronic document 128 to provide configuration data 126 pertaining to settings of the application feature via the UI. Client device 102 can obtain configuration data 126 for the application feature based on the user interaction and can provide the obtained configuration data 126 to platform 120 (e.g., via network 104). Configuration manager 132 can generate the configuration file for the application feature based on the electronic document and the configuration data 126 provided by the user, as described herein. Platform 120 and/or client device 102 can provide a user with access to the feature by execution of the configuration file, in accordance with embodiments described herein.

In some embodiments, platform 120 may receive a request to or may otherwise detect an update to a base functionality of the application feature and/or an underlying resource of the feature. For example, the source code for the application feature can be programmed according to a particular programming language (e.g., Python) and platform 120 can receive notice that an updated version of the programming language is available. Platform 120 can update the source code for the application feature based on the update and can regenerate or update the configuration file for the application feature based on the updated source code mapped to the electronic document 128 and the configuration data 126 (e.g., previously provided by the user of client device 102). Platform 120 and/or client device 102 can execute the regenerated or updated configuration file to provide the user with continuous access to the application feature, as described herein.

It should be noted that although FIG. 1 depicts configuration manager 132 as part of platform 120, configuration manager 132 can reside at any component of system 100. For example, configuration manager 132 can reside at a server machine 130 that is accessible to platform 120 (e.g., via network 104). In another example, configuration manager 132 can reside at one or more nodes 140 of system 100.

In some implementations, platform 120, server machine 130, and/or platforms 150 may operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components. In some implementations, the functions of platform 120 and/or server machines 130-150 may be provided by a more than one machine. For example, in some implementations, the functions of configuration manager 132 and/or application instance manager 142 may be provided by two or more separate server machines. Platform 120 server machine 130, and/or platforms 150 may also include a website (e.g., a webpage) or application back-end software that may be used to enable a user to access media items, as described herein.

In general, functions described in implementations as being performed by platform 120 can also be performed on the client devices 102 in other implementations, if appropriate. In addition, the functionality attributed to a particular component can be performed by different or multiple components operating together. Platform 120 can also be accessed as a service provided to other systems or devices through appropriate application programming interfaces, and thus is not limited to use in websites.

It should be noted that although some embodiments of the present disclosure are directed to a content sharing platform, embodiments of this disclosure can be applied to other types of platforms. For example, embodiments of the present disclosure can be applied to a content archive platform, a content storage platform, etc.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the platform 120.

In situations in which the systems discussed here collect personal information about users, or can make use of personal information, the users can be provided with an opportunity to control whether platform 120 collects user information (e.g., information about a user's social network, social actions or activities, profession, a user's preferences, or a user's current location), or to control whether and/or how to receive content from the content server that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the platform 120.

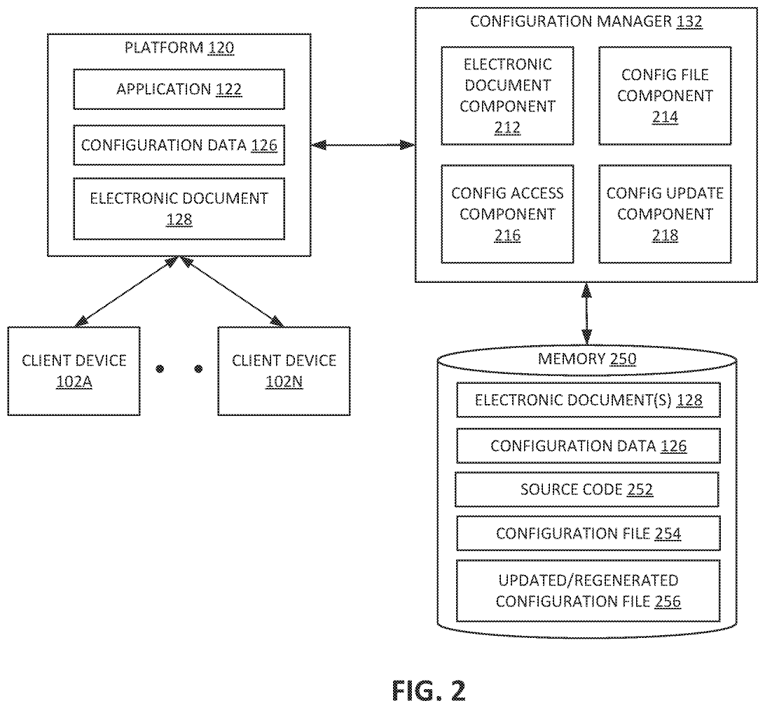

FIG. 2 is a block diagram illustrating a platform 120 and a configuration manager 132, in accordance with an implementation of the disclosure. As described above, platform 120 can provide users (e.g., of client devices 102) with access to an application 122 via instances of application 122 (not shown) at client device(s) 102. The application 122 can include one or more application features, as described above. Access to application features of application 122 can be defined based on configuration data 126 associated with a respective user (or group of users). Configuration manager 132 can manage configuration data 126 associated with a user's access to an application feature and, in some embodiments, can generate and/or update a configuration file that, when executed, provides a user with access to the application feature, as described herein.

As illustrated in FIG. 2, configuration manager 132 can include an electronic document component 212, a configuration file component 214, a configuration update component 216, and/or a configuration access component 218. Configuration manager 132 and/or platform 120 can be connected to memory 250. In some embodiments, platform 120 and/or configuration manager 132 can be connected to memory 250 (e.g., via network 104, via a bus, etc.). Memory 250 can correspond to one or more regions of data store 110, in some embodiments. In other or similar embodiments, one or more portions of memory 250 can include or otherwise correspond any memory of or connected to system 100.

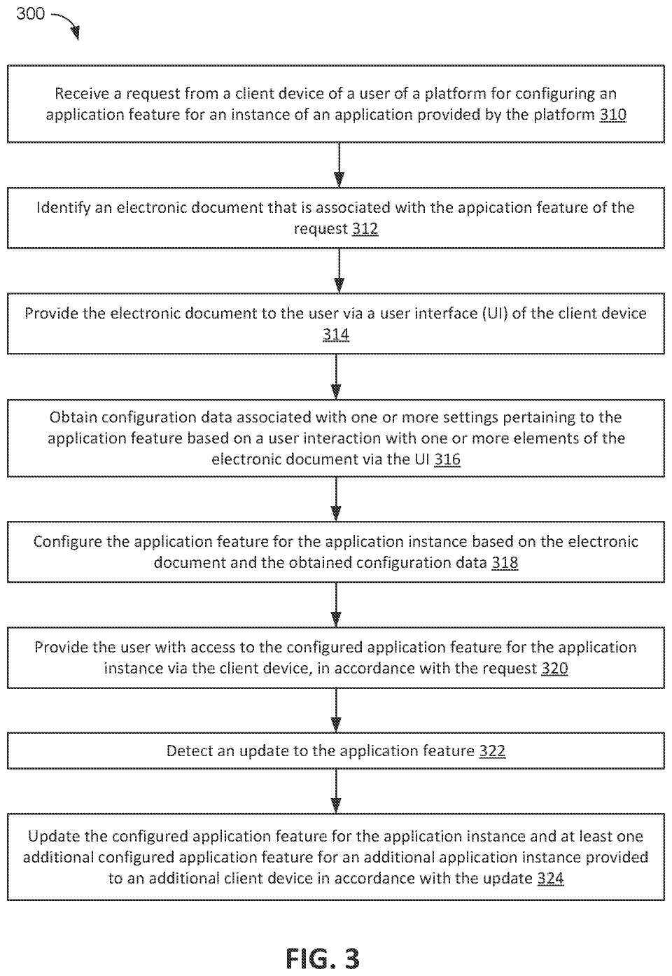

FIG. 3 is a flow diagram illustrating an example method 300 for configuring application features in a cloud-based environment, in accordance with an implementation of the disclosure. Method 300 can be performed by processing logic that can include hardware (circuitry, dedicated logic, etc.), software (e.g., instructions run on a processing device), or a combination thereof. In one implementation, some or all of the operations of method 300 can be performed by one or more components of system 100 of FIG. 1. In some embodiments, some or all of the operations of method 300 can be performed by configuration manager 132, as described herein.

At block 310, processing logic receives a request from a client device of a user of a platform for configuring an application feature for an instance of an application provided by the platform. In some embodiments, platform 120 can receive a request from a client device 102 for configuring of an application feature for an application instance 124 running via the client device 102. The platform 120 can offer multiple application features for application 122. In some embodiments, platform 120 can offer each of the application features for application 122 to each user accessing application 122 (e.g., via a digital marketplace). In an illustrative example, the user can provide a request for configuring the application feature by requesting access to the application feature (e.g., via one or more elements of the digital marketplace). It should be noted that platform 120 can offer application features to users according to other techniques, in accordance with embodiments of the present disclosure.

In response to receiving the request for configuring the application feature, platform 120 can forward or otherwise provide the request (e.g., via network 104, via a bus, etc.) to configuration manager 132. At block 312, processing logic identifies an electronic document that is associated with the application feature of the request. Electronic document component 212 of configuration manager 132 can identify the electronic document 128 that corresponds to the application feature. As described above, configuration manager 132 and/or platform 120 can maintain multiple electronic documents 128 that each correspond to a respective application feature for application 122. In an illustrative example, a first electronic document 128 can correspond to a notification or messaging-based application feature and a second electronic document 128 can correspond to a CRM-based application feature. Each electronic document 128 can include one or more elements that each correspond to a setting pertaining to a respective application feature and/or an underlying resource that supports the application feature. FIG. 4A illustrates an example electronic document 128, according to embodiments of the present disclosure.

As described above, FIG. 4A depicts an example electronic document 128 associated with an application feature of application 122 (e.g., as provided to a user via UI of a client device 102, as described below). For purposes of example and illustration only, electronic document 128 can be associated with an application feature that enables an application instance 122 to provide or otherwise access data associated with an application associated with another platform 150 of system 100. The application feature can also enable the performance of one or more operations (e.g., updating the data, adding data to a database, removing data from the database, etc.). Electronic document 128 can include one or more elements 402 that correspond to settings pertaining to the application feature, as described below. It should be noted that electronic document 128 can correspond to any type of application feature and can include any type of elements that correspond to any type of settings for an application feature.

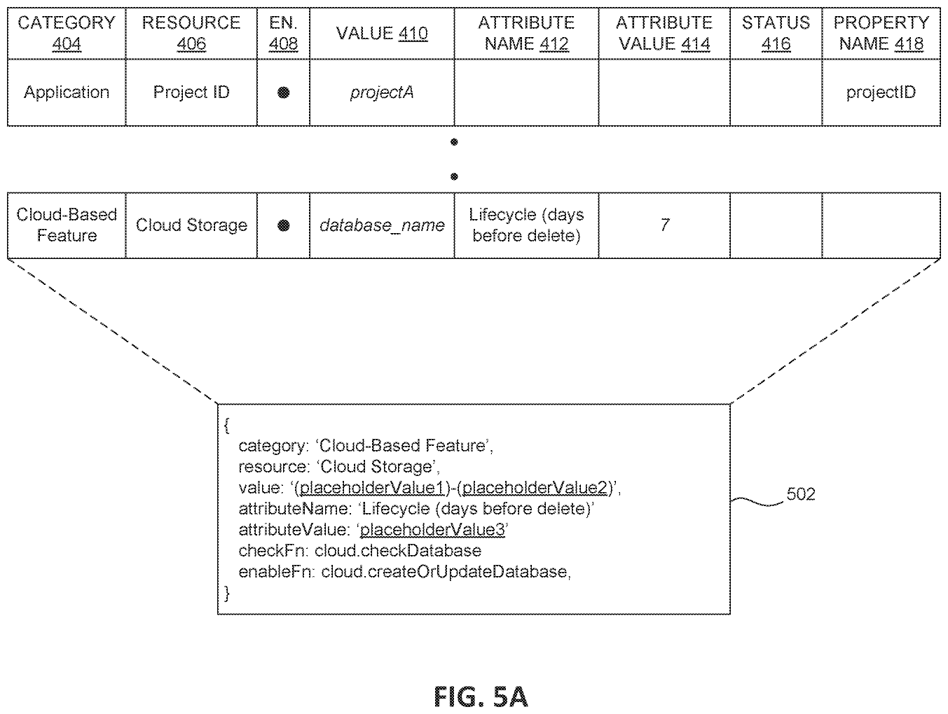

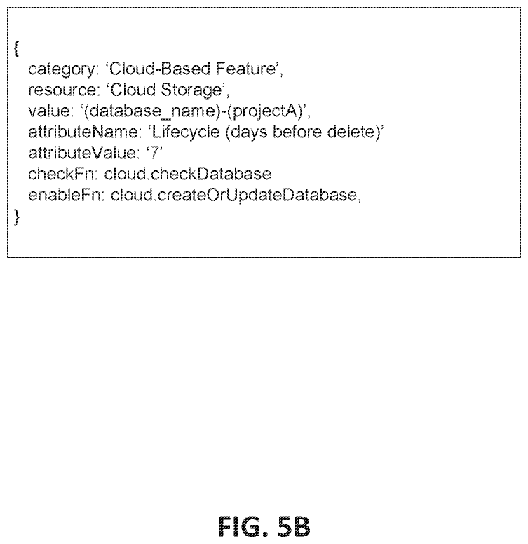

In accordance with previously described embodiments, electronic document 128 can include or otherwise correspond to a form that can be edited by a user to provide configuration data 126 pertaining to an application feature. In accordance with examples and embodiments described with respect to FIGS. 4A-5B, the electronic document 128 can be a spreadsheet electronic document and can include an editable form that is composed of cells of the spreadsheet electronic document. However, electronic document 128 can be any type of electronic document (e.g., a word processing document, a web page document, a slide presentation document, etc.) and the editable form can be composed of any type of elements of the electronic document.

In some embodiments, electronic document 128 can include one or more entries that each include one or more fields. Each entry of the electronic document can represent a respective element 402 of the electronic document 128, where each respective element 402 corresponds to a setting pertaining to the application feature. In accordance with the examples and embodiments described with respect to FIG. 4A, a row of the spreadsheet document can represent an element 402 (or a portion of an element 402) of the electronic document 128. As will be described in further detail herein, each cell of a row of the spreadsheet document may include a data item (e.g., a text string data item, a Boolean data item, a numeric value data item, a function, etc.). In some embodiments, a developer or programmer associated with the application feature can provide data items for one or more cells of the rows of the spreadsheet document (e.g., via a client device 102 associated with the developer or programmer). The cells that include data items can indicate to a user accessing the electronic document a type of information or data that is to be provided in other cells of the row (e.g., in accordance with features or a functionality of the application feature. Other cells of the row may not include a data item. Such cells may be editable by a user accessing the electronic document 128, in accordance with embodiments described herein.

As illustrated in FIG. 4A, each entry (or element 402) of electronic document 128 can include a category field 404. Category field 404 can indicate a category of the setting pertaining to the application feature. Values of the category field 404 can be provided by a developer or programmer of the application feature, as described above. In accordance with the example of FIG. 4A, the category field 404 of each entry may either have a value of “application” or “cloud-based feature.” Entries with a category of “application” can correspond to settings for the application 122 that enable the cloud-based feature. Entries with a category of “cloud-based feature” can correspond to settings for the application feature (e.g., irrespective of settings for application 122).

Each entry (or element 402) of electronic document 128 can additionally or alternatively include a resource field 406. Resource field 406 can indicate a resource that is subject to the setting associated with the entry, in some embodiments. Values of the resource field 406 can be provided by a developer or programmer of the application feature, as described above. In accordance with the example of FIG. 4A, the resource field 406 can have a value of “project ID,” “permissions,” “APIs,” “location,” and so forth.

Each entry (or element 402) of electronic document 128 can additionally or alternatively include an enabled field 408. Enabled field 408 can indicate whether a resource (e.g., indicated by resource field 406) is enabled by the application feature. In some embodiments, values of the enabled field 408 can be provided by a developer or programmer of the application feature. In other or similar embodiments, values of the enabled field 408 can be provided by a user of the application feature. In an illustrative example, entries pertaining to settings that have to be enabled (e.g., according to the functionality of the application feature) can have a particular Boolean value (e.g., “yes,” “1,” a black dot, etc.) in the enabled field 408 (e.g., as set by the programmer or developer of the application feature. Entries pertaining to settings that can optionally be enabled (e.g., according to user preference) can include a non-Boolean value (e.g., a check box) that can be selected by the user in the enabled field 408 (e.g., to enable the resource). It additional or alternative embodiments, multiple entries can be associated with a common enable field. If the common enable field for one of the multiple entries indicates that a settings is enabled (or not enabled), such setting will be applied to the other entries that are associated with the common enable field.

Each entry (or element 402) of electronic document 128 can additionally or alternatively include a value field 410. The value field 410 can be editable by a user (or a programmer or developer) to indicate a value of a setting pertaining to the application feature. Values provided to the value field can correspond to the resource and category of the setting, as described above. Further details regarding example values provided to the value field are described with respect to FIGS. 5A and 5B.

Each entry (or element 402) of electronic document 128 can additionally or alternatively include other fields (e.g., attribute name field 412, attribute value field 414, status field 416, property name field 418, etc.). As described above, the values of each field can be provided by a programmer or developer of the application feature and/or the user of the application feature. In some cases, a programmer or developer can provide instructions (e.g., with electronic document 128) that guide a user on how to provide values to fields of entries of electronic document 128. Further details regarding the values provided to each field of each entry and configuration data obtained based on user interaction with the entries or elements of electronic document 128 are provided herein with respect to FIGS. 5A-5B.

As described above, electronic document component 212 of configuration manager 132 can identify the electronic document 128 that corresponds to the application feature from multiple electronic documents. In some embodiments, a developer or programmer of application 122 (or another user or entity associated with application 122) can provide the electronic documents to platform 120 (e.g., via a client device 102), where each provided electronic document corresponds to a respective feature associated with application 122. In additional or alternative embodiments, a developer or programmer of application 122 (or another user or entity) can provide a single electronic document 128 that corresponds to each feature associated with application 122. In such embodiments, the electronic document 128 can include multiple sections, where each section corresponds to a respective application feature of application 122. Each section can include elements that correspond to settings pertaining to the respective application feature, as described above. In response to a request for configuring of a particular application feature of application 122, electronic document component 212 can identify a section of the electronic document 128 that corresponds to the application feature of the request, as described herein.

Referring back to FIG. 3, at block 314, processing logic provides the electronic document to the user via a user interface (UI) of the client device. In some embodiments, electronic document component 212 can provide (e.g., via network 104) the identified electronic document 128 associated with the application feature of the request to the client device 102 that provided the request. As described above, in some embodiments, a single electronic document 128 can include multiple sections including elements corresponding to settings pertaining to multiple features of application 122. In such embodiments, electronic document component 212 can identify a section of the electronic document 128 that corresponds to the application feature of the request and can provide the identified section to client device 102.

Client device 102 can provide the electronic document 128 (or a section of the electronic document 128) to a user of client device 102 via a UI of the client device 102. As indicated above, FIG. 4A, depicts a UI of a client device 102, which presents at least a portion of the electronic document 128 (or a section of the electronic document 128) to a user of client device 102. In accordance with previously described embodiments, the UI can provide, to a user, the one or more elements 402 of the electronic document. In some embodiments, an element 402 may include a value in one or more fields (e.g., category field 404, resource field 406, etc.), as provided by a programmer or developer associated with the application feature and/or the application 122. In other or similar embodiments, other or additional fields of the element 402 may not include any value. A user may engage with such elements 402 (e.g., via the UI of the client device 102) to provide configuration data pertaining to the setting that corresponds with the element 402.

FIG. 5A illustrates example configuration data provided by a user by engagement with one or more elements 402 of electronic document 128. As illustrated in FIG. 5A, a user can provide a value of “projectA” in a value field 410 of an entry 402 corresponding to a project ID setting for an application feature. As also illustrated in FIG. 5A, a user can provide a value of “database_name” in a value field 410 of an entry 402 corresponding to a cloud storage resource for the cloud-based feature and/or can provide a value of “7” in an attribute value field of the entry. The value of “database_name” can indicate a name of a database residing at or otherwise associated with the cloud storage resource that is to be accessed or otherwise configured for the application feature, in some examples. The value of “7” can indicate a number of days between delete processes (e.g., to erase or refresh data) at the database, in other or similar examples.

Referring back to FIG. 4A, the UI provided to the user via client device 102 can include one or more additional elements, e.g., of a menu bar 420. The one or more additional elements can enable the user to access and/or initiate one or more functions or commands pertaining to the electronic document 128. For example, as illustrated in FIG. 4A, menu bar 420 can include a “file” element. In response to engaging with the “file” element, the UI of client device 102 can be updated to present the user with options for creating, opening, saving, printing, etc. the electronic document 128. In another example, the menu bar 420 can include an “edit” element. In response to engaging with the “edit” element, the UI of client device 102 can be updated to present the user with options for modifying content (e.g., cutting, copying, pasting, etc.) and/or properties (e.g., font, font size, font format, etc.) of the electronic document 128. The menu bar 420 can include other or additional types of elements, such as a “view” element (e.g., that enables a user to customize a view of the elements 402 of the electronic document 128 via the UI of client device 102), an “insert” element (e.g., that enables the user to add various elements, such as charts, images, hyperlinks, etc. into the content of the electronic document 128), and so forth. It should be noted that one or more elements of the menu bar 420 can be common elements that are provided with each electronic document 128 supported by platform 120. For example, platform 120 can provide other users with access to electronic documents that do not correspond to application features of a cloud-based application. In such example, the UI that provides users with access to such electronic documents can include a menu bar 420 that includes a “file” element, an “edit” element, etc. The menu bar of such UI may not include elements that are associated with the execution or deployment of the application feature (e.g., “deploy” element 422), as described below.

In some embodiments, the menu bar can include a “deploy” element 422. Upon detecting a user engagement with the deploy element 422, client device 102 (or platform 120) can update the UI of client device 102 to include one or more elements that enable the user to access and/or initiate one or more functions or commands to deploy the application feature in accordance with the configuration data provided by the user (e.g., via the elements 402 of electronic document 128). FIG. 4B illustrates example additional elements that are provided via the UI of client device 102, in accordance with embodiments of the present disclosure. In some embodiments, the additional elements associated with deploy element 422 can include one or more sub-menu elements 430. Each sub-menu element 430 can correspond to a respective category or set of functions or commands associated with deploying the application feature. In some embodiments, a user can engage (e.g., select, click, tap, hover over, etc.) a sub-menu element 430 by interacting with the UI of client device 102. Upon detecting the user engagement, client device 102 (or platform 120) can update the UI to provide one or more function elements 432 that correspond to a respective function or command associated with deploying the application feature. The user can engage with a function element 432 to access and/or initiate a function or command associated with deploying the application feature, in some embodiments.

In an illustrative example, a sub-menu element 430 can correspond to a “feature” sub-menu, which corresponds to a category or set of functions or commands associated with the application feature. Upon detecting a user engagement with the “feature” sub-menu element, client device 102 (or platform 120) can update the UI to include one or more function elements 432 corresponding to functions or commands associated with the application feature. For example, as illustrated in FIG. 4B, the UI can include a “check resources” function element (e.g., that initiates execution of one or more commands associated with checking a state or status of one or more underlying resources of the application feature), an “apply changes” function element (e.g., that initiates execution of one or more commands to update a configuration file to include updated configuration data provided by the user via elements 402 of electronic document 128), a “reset document” function element (e.g., that initiates execution of one or more commands to remove or otherwise erase configuration data provided by the user via elements 402 of the electronic document 128), and so forth.

In another illustrative example, a sub-menu element 430 can correspond to a “feature configuration” sub-menu, which corresponds to a category or set of functions or commands associated with configuring the application feature. Upon detecting a user engagement with the “feature configuration” sub-menu element, client device 102 (or platform 120) can update the UI to include one or more function elements 432 corresponding to functions or commands associated with configuring the application feature. For example, as illustrated in FIG. 4B, the UI can include a “check configuration for accessibility” function element (e.g., that initiates execution of one or more commands to check or otherwise confirm that the user-provided configuration data satisfies one or more accessibility criteria for application 122), a “update configuration to storage” function element (e.g., that initiates execution of one or more commands to store the user-provided configuration data in memory, such as memory 250), an “upload data to test feature” function element (e.g., that initiates execution of one or more commands to upload or otherwise provide the user-provided configuration data for a test application feature), an “update all configurations” function element (e.g., that initiates execution of one or more commands to update one or more configuration files associated with the application feature and/or application 122 based on the user-provided configuration data), and so forth.

In yet another illustrative example, a sub-menu element can correspond to a “security manager” sub-menu, which corresponds to a category or set of functions or commands associated with security and authorization of access to the application feature. Upon detecting a user engagement with the “security manager” sub-menu element, client device 102 (or platform 120) can update the UI to include one or more function elements 432 corresponding to functions or commands associated with security and authorization of access to the application feature. For example, as illustrated in FIG. 4B, the UI can include a “refresh secret” function element (e.g., that initiates execution of one or more commands to refresh or regenerate a secret value associated with a security or authentication protocol), and so forth.

It should be noted that the elements and their corresponding functionalities as illustrated and described with respect to FIG. 4B are provided for purposes of example and illustration only. Any type of function element and/or sub-menu element can be associated with a respective application feature and/or provided to a user via a UI, in accordance with embodiments of the present disclosure. It should also be noted that elements described with respect to FIGS. 4A and 4B, or any other element associated with an application feature in accordance with embodiments of the present disclosure, can be presented or organized according to other techniques. For example, menu bar 420 can, in accordance with embodiments of the present disclosure, include a feature element, a feature configuration element, a security manager element, etc. (e.g., instead of a deploy element 422 that includes the “feature,” “feature configuration,” and “security manager” sub-menu elements.

Referring back to FIGS. 2 and 3, a user can provide configuration data 126 associated with the settings pertaining to the application feature by engaging with elements 402 of electronic document 128, as described above. At block 316, processing logic obtains configuration data associated with one or more settings pertaining to the application feature based on a user interaction with one or more elements of the electronic document via the UI. During or upon completion of the user providing the configuration data 126 via the elements 402 of electronic document 128, client device 102 can provide the user-provided configuration data 126 to platform 120 (e.g., via network 104, via a bus, etc.). Electronic document component 212 of configuration manager 132 can store the configuration data 126 at memory 250, in some embodiments.

At block 318, processing logic configures the application feature for the application based on the electronic document and the obtained configuration data. As described above, each element of the electronic document can be mapped to one or more operations that, when executed, enable at least a portion of the application feature according to at least one setting pertaining to the application feature. In some embodiments, the one or more operations can be included in source code 252 that is associated with the application feature. The source code 252 can include one or more operations that correspond to functions of the application feature. The source code 252 can be provided by a programmer or developer associated with the application feature, in some embodiments. The mappings between the source code 252 and the corresponding elements 402 of electronic document 128 can be provided by the programmer or developer, in some embodiments. In other or similar embodiments, a component of platform 120 (or another entity of system 100) can generate the mappings between source code 252 and the corresponding elements 402. In some embodiments, source code 252 can be included in a source code file (e.g., that is separate from electronic document 128). In other or similar embodiments, source code 252 can be included in content or metadata for electronic document 128.

FIG. 5A illustrates example source code 502 mapped to one or more elements 402 of electronic document 128. As illustrated in FIG. 5A, an element 402 of electronic document 128 can correspond to one or more settings for a cloud storage resource of the application feature. The source code 502 mapped to the element 402 can include data or information pertaining to values provided via the cells of element 402 (e.g., by the programmer or developer of the application feature). For example, source code 502 can include an object (or other such code element) that corresponds to the category of the setting pertaining to the application feature (e.g., “category: ‘Cloud-Based Feature’). In another example, source code 502 can include an object (or other such code element) that corresponds to a resource of the setting pertaining to the application feature (e.g., “resource: ‘Cloud Storage’). Source code 502 can include one or more additional objects that correspond to other values provided to cells of element 402, as described herein.

As described above, a developer or programmer can provide values to elements 402 pertaining to the settings for an application feature, in some embodiments. In other or similar embodiments, a user can provide values to elements 402 (e.g., as configuration data 126 described above). In some embodiments, source code 502 can include placeholder values that are mapped to the values of cells that are to be provided by a user that is requesting a configuration for the application feature. Upon generation of a configuration file for a configuration of the application feature for a user, the placeholder values can be replaced with values provided by the user, as described herein. The placeholder values can be included in the source code by a programmer or developer of the application feature and/or can be determined by platform 120 (or another entity of system 100). For example, platform 120 (or another entity of system 100) can determine which sections of source code 502 are to include placeholder values based on a historical or experimental activity associated with the application feature.

As illustrated in FIG. 5A, source code 502 can include a first placeholder value (e.g., “placeholderValue1”) that corresponds to a value that is to be provided by a user in a cell of element 402 for a name of a database of cloud storage that is accessed by the application feature, in one example. In an additional or alternative example, source code 502 can include a second placeholder value (e.g., “placeholderValue2”) that corresponds to a value that is to be provided by a user in a cell of element 402 (or another element 402) for an identifier for a project associated with the application feature. In yet an additional or alternative example, source code 502 can include a third placeholder value (e.g., “placeholderValue3”) that corresponds to a value that is to be provided by a user in a cell of element 402 for a length of a lifecycle for data in the database indicated by the other cell of element 402. It should be noted that source code 502 can include placeholder values in other sections and that the above described examples are provided for the purposes of illustration only and are not intended to be limiting.

In some embodiments, source code 502 can also include one or more objects (or other such code elements) associated with a function associated with the application feature. In some embodiments, values provided to the cells of element 402 can be provided (e.g., as input) for execution of the function. Such values can be mapped to other objects (or other such code elements) of source code 502 and/or can be mapped directly to the function, in accordance with embodiments of the present disclosure. As illustrated in FIG. 5A, source code 502 can include an object associated with a check function (e.g., “checkFn: cloud.checkDatabase”) that, when executed, initiates one or more operations pertaining to checking a status or state of a database accessed by the application feature. Source code 502 can additionally or alternatively include an object associated with an enable function (e.g., “enableFn: cloud.createOrUpdateDatabase”), that, when executed, initiates one or more operations pertaining to accessing the database, according to the application feature.

Configuration file component 214 can configure the application feature for the application by generating a configuration file 254 for the application feature based on the electronic document and the configuration data 126 (e.g., provided by the user of client device 102). In some embodiments, configuration file component 214 can generate the configuration file 254 by replacing the placeholder values mapped to cells of the elements 402 of electronic document 128 to include values provided to the cells by the user of client device 102. For example, as illustrated with respect to FIG. 5B, configuration file component 214 can replace “placeholderValue1” of source code 502 to include “database_name,” as provided by the user of client device 102 in the cell of element 402 for the name of the database of cloud storage that is accessed by the application feature. In an additional or alternative example, configuration file component 214 can replace “placeholderValue2” of source code 502 to include “projectA,” as provided by the user of client device 102 in the cell of element 402 (or another element 402) for the identifier for a project associated with the application feature. In yet an additional or alternative example, configuration file component 214 can replace “placeholderValue3” of source code 502 to include “7,” as provided by the user of client device 102 in the cell of element 402 for a length of a lifecycle for data in the database indicated by the other cell of element 402. It should be noted that a placeholder value of source code 502 can be replaced with any configuration data item provided by a user, in accordance with embodiments of the present disclosure. For example, data provided to any fields (e.g., fields 404-418) can be used to replace a placeholder value of source code 502, as described herein.

In additional or alternative embodiments, a placeholder value indicated by source code 502 can be associated with a default value that pertains to the settings associated with an element 402 of the electronic document. In some embodiments, the default value may be provided or otherwise defined by a developer or programmer associated with the application feature. In other or similar embodiments, platform 120 and/or configuration manager 132 can determine the default value (e.g., based on historical or experimental data associated with the application and/or the application feature). If a user does not provide a value for a setting associated with the element 402, the placeholder value of source code 502 may be replaced with the default value.

In some embodiments, configuration file component 214 can update the source code 252 of the source code file provided by the programmer and/or the developer to replace the placeholder values with values provided via the cells of the elements 402, as described above. The updated source code file can be or otherwise correspond to configuration file 254, in such embodiments. In other or similar embodiments, configuration file component 214 can generate a copy of the source code file that includes source code 252 and can replace the placeholder values included in the copied source code file, as described above. In such embodiments, the copied source code file can be or otherwise correspond to configuration file 254.

Referring back to FIG. 3, at block 320, processing logic provides the user with access to the configured application feature for the application instance via the client device, in accordance with the request. In some embodiments, configuration access component 216 of configuration manager 132 can execute the configuration file 254 (e.g., via computing resources of platform 120) to provide the user with access to the configured application feature. Upon executing the configuration file 254, configuration access component 216 can enable the user of client device 102 to access functionalities of the application feature. For example, the application feature can enable the sharing of data between two or more applications (e.g., of platform 120 and/or another platform 150). Upon executing of the configuration file 254, configuration access component 216 can provide the user with access to the data of the two or more applications (e.g., via a UI of the platform 120 and/or a UI of another platform 150). In other or similar embodiments, configuration access component 216 can provide the configuration file 254 to the client device 102 that provided the request for configuring of the application feature. The client device 102 can execute the configuration file (e.g., using computing resources of the client device 102) to provide the user with access to the configured application feature, as described herein.

In some embodiments, a user may update configuration data provided via elements 402 of the electronic document (e.g., after the user is provided with access to the configured application feature). For example, the user may initially provide an identifier associated with a first database that is accessed using the application feature, according to previously described embodiments. After configuration of the application feature for the user, the user may update the electronic document to include an identifier associated with a second database that is to be accessed using the application feature (e.g., instead of the first database). Configuration manager 132 can generate an updated configuration file 256 for the configuration of the application feature based on the updated configuration information provided by the user, in accordance with embodiments described herein. Upon generating the updated configuration file 256, platform 120 and/or configuration manager 132 may provide the user with access to the application feature based on the updated configuration file 256, as described herein.

In some embodiments, configuration manager 132 can configure an application feature for application instances running on different client devices 102 of system 100 according to distinct configuration data 126 provided by users of each client device 102. For example, configuration manager 132 can configure the application feature for a first application instance 124A running on client device 102A based on configuration data 126 provided by a user of client device 102A. Configuration manager 132 can also configure the application feature for a second application instance 124B running on client device 102B based on configuration data 126 provided by a user of client device 102B (which may be different from the configuration data 126 provided by the user of client device 102B). Configuration manager 132 can provide the users of client devices 102A and 102B with access to the configured application features according to the user interaction with electronic document 128 via client devices 102A and 102B, as described above.

At block 322, processing logic detects an update to the application feature. In some embodiments, the update can correspond to a change or modification made to the base configuration framework for the application feature. For example, a developer or programmer can modify or update a portion of source code 252 associated with the application feature. In another example, source code 252 for the base configuration framework can be programmed according to a particular programming language (e.g., Python, etc.). An updated version of the programming language can be released, and compilers for the programming language can be modified to accommodate the updated version of the programming language. The modified compilers may no longer support source code 252 that is programmed according to the prior version of the programming language, and accordingly platform 120 cannot provide users with access to the application feature unless the source code 252 is updated to reflect the updated version of the programming language. In other or similar embodiments, the update can correspond to a change or modification made to an underlying resource that supports the application feature. In another example, an application feature can access and/or modify data of another application 152 hosted by another platform 150 via an API. The platform 150 that hosts the other application 152 may update or otherwise modify the API for the application 152. The application feature may not access and/or modify the data of the other application 152 until source code 252 and/or configuration file 254 for the application feature is updated in accordance with the update/modification to the API.

In some embodiments, configuration update component 218 of configuration manager 132 can detect the update to the application feature based on a message or notification received from platform 120 and/or platform 150. In other or similar embodiments, configuration update component 218 can detect the update based on a message or notification received from a client device 102 associated with a programmer or developer of the application feature and/or based on a modification made to source code 252 by a programmer or developer of the application feature. In yet other or similar embodiments, configuration update component 218 can detect the update to the application feature by detecting that one or more functions pertaining to the application feature can not be executed and/or are not executing as expected (e.g., according to the functionality of the application feature).

At block 324, processing logic updates the configured application feature for the application instance and at least one additional configured application feature for an additional application instance provided to an additional client device in accordance with the update. In some embodiments, configuration update component 218 can update the configured application feature for an application instance 124 that is accessing the feature based on the source code 252 (or updated source code) for the application feature and the user-provided configuration data 126. In some embodiments, configuration update component 218 can obtain updated source code for the application feature from a client device 102 associated with a developer or programmer for the application feature. In other or similar embodiments, platform 120 can update the source code 252 for the application feature in accordance with a notification received from the client device 102 associated with the developer or programmer for the application feature (or from another entity of system 100). For example, platform 120 can receive a notification that an updated version of the programming language for the source code has been released. Platform 120 can update the source code 252 according to the updated version of the programming language, in some embodiments. In such embodiments, configuration update component 218 can generate the updated/regenerated configuration file 256 based on the updated source code and the user-provided configuration data 126, in accordance with previously described embodiments. Configuration access component 216 and/or client device 102 can execute the updated/regenerated configuration file 256 to provide the user with (e.g., continuous) access to the application feature, as described herein.

As indicated above, in some embodiments, the update to the application feature is detected based on a change or modification to an underlying resource that supports the application feature. In such embodiments, a platform (e.g., platform 120, platform 125, etc.) associated with the underlying resource can provide platform 120 with a notification indicating the change or modification. Configuration update component 218 can modify source code 252 based on the update. The updated source code can be used to generate the updated/regenerated configuration file 256, as described above. In additional or alternative embodiments, the platform associated with the underlying resource may request additional configuration data in order to continue access to the resource in accordance with the update. In such embodiments, platform 120 can provide the additional configuration data to the platform, if available to platform 120. In other or similar embodiments, configuration update component 218 can transmit a notification to client device 102 indicating the additional configuration data that is requested by the platform associated with the underlying resource. Client device 102 can provide the notification to the user of client device 102, in some embodiments. In some embodiments, the user can provide the requested additional configuration data via the UI of client device 102, as described herein. Client device 102 can provide the additional configuration data to configuration manager 132. Configuration update component 218 can generate the updated/regenerated configuration file 256 based on the additional configuration data, in accordance with previously described embodiments.

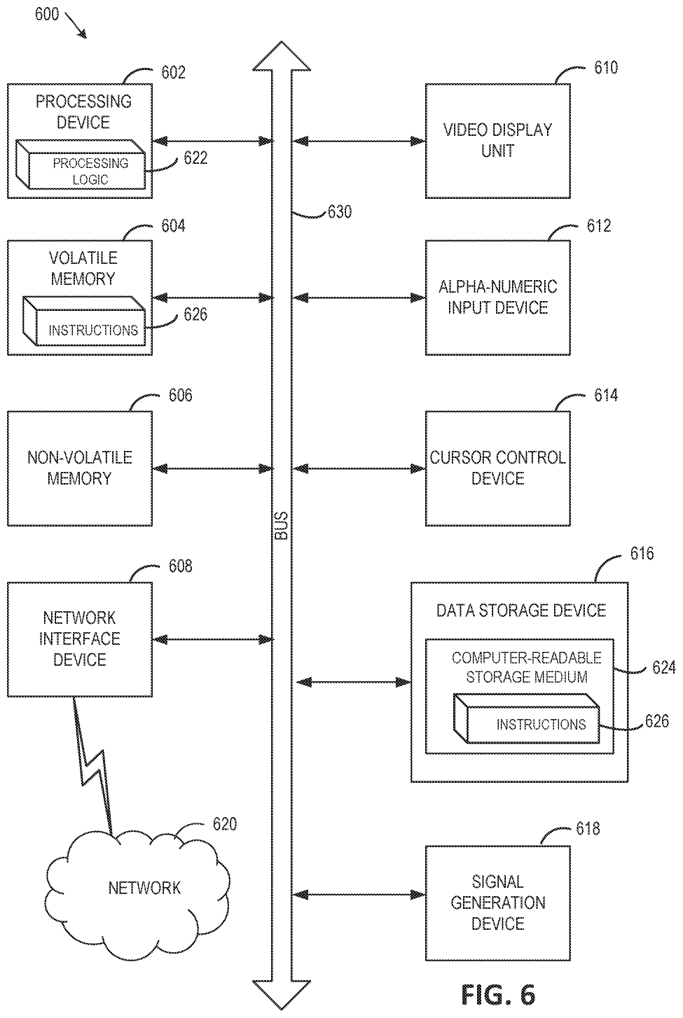

FIG. 6 is a block diagram illustrating an exemplary computer system, in accordance with implementations of the present disclosure. The computer system 600 can be platform 120, platform 150, server machine 130, and/or client devices 102A-N in FIG. 1. The machine can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 605 for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker).

The data storage device 618 can include a non-transitory machine-readable storage medium 624 (also computer-readable storage medium) on which is stored one or more sets of instructions 605 embodying any one or more of the methodologies or functions described herein. The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above. The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving a request from a client device of a user of a platform for configuring an application feature, of a plurality of application features, for an instance of an application provided by the platform;
identifying, from a plurality of electronic documents, an electronic document associated with the application feature of the request, wherein each of the plurality of electronic documents is associated with a respective application feature of the plurality of application features, and wherein each of the plurality of electronic documents comprises elements that enable users to configure settings pertaining to a respective application feature;
providing the electronic document for presentation to the user;
obtaining configuration data associated with one or more settings pertaining to the application feature based on a user interaction with one or more elements of the electronic document;
configuring the application feature for the application instance based on the electronic document and the obtained configuration data; and
providing the user with access to the configured application feature for the application instance via the client device, in accordance with the request.

2. The method of claim 1, further comprising:
responsive to an additional request from an additional client device associated with an additional user of the platform for configuring the application feature for an additional application instance associated with the additional user, configuring the application feature for the additional application instance based on the electronic document and additional configuration data provided by the additional user; and
providing the additional user with access to the configured application feature for the additional application instance via the additional client device.

3. The method of claim 2, further comprising;
detecting an update to the application feature; and
updating the configured application feature for the application instance at the client device and for the additional application instance at the additional client device in response to the detection.

4. The method of claim 1, wherein at least one setting of the one or more settings pertaining to the application feature is associated with an application resource provided by another application of the platform or another platform.

5. The method of claim 1, wherein each element of the electronic document is mapped to one or more operations that, when executed, enable at least a portion of the application feature according to at least one setting pertaining to the application feature, and wherein configuring the application feature for the application instance based on the electronic document and the obtained configuration data comprises:
generating a configuration file for the application feature based on the one or more operations and the obtained configuration data; and
providing the generated configuration file for execution.

6. The method of claim 5, wherein the one or more operations are included in a source code file associated with the application feature, the source code file comprising one or more placeholder values that reference configuration data items, and wherein generating the configuration file for the application feature based on the one or more operations and the obtained configuration data comprises:
obtaining a copy of the source code file including the one or more operations and the one or more placeholder values;
modifying the copy of the source code file to replace at least one of the one or more placeholder values with a configuration data item of the obtained configuration data.

7. The method of claim 1, wherein the client device is associated with an organization and the application instance is running using one or more additional client devices associated with the organization, and wherein the method further comprises:
providing one or more additional users associated with the one or more additional client devices with access to the configured application feature for the application instance via the one or more additional client devices.

8. The method of claim 1, wherein the application feature comprises at least one of a notification-based feature, a messaging-based feature, a storage-based feature, a data sharing-based feature, a data collection-based feature, a data visualization-based feature, a user workflow-based feature, a customer relationship management (CRM)-based feature, an accounting-based feature or an auditing-based feature.

9. A system comprising:
a memory device; and
a processing device coupled to the memory device to perform operations comprising:
receiving a request from a client device of a user of a platform for configuring an application feature, of a plurality of application features, for an instance of an application provided by the platform;
identifying, from a plurality of electronic documents, an electronic document associated with the application feature of the request, wherein each of the plurality of electronic documents is associated with a respective application feature of the plurality of application features, and wherein each of the plurality of electronic documents comprises elements that enable users to configure settings pertaining to a respective application feature;
providing the electronic document for presentation to the user;
obtaining configuration data associated with one or more settings pertaining to the application feature based on a user interaction with one or more elements of the electronic document;
configuring the application feature for the application instance based on the electronic document and the obtained configuration data; and
providing the user with access to the configured application feature for the application instance via the client device, in accordance with the request.

10. The system of claim 9, wherein the operations further comprise:
responsive to an additional request from an additional client device associated with an additional user of the platform for configuring the application feature for an additional application instance associated with the additional user, configuring the application feature for the additional application instance based on the electronic document and additional configuration data provided by the additional user; and
providing the additional user with access to the configured application feature for the additional application instance via the additional client device.

11. The system of claim 10, wherein the operations further comprise:
detecting an update to the application feature; and
updating the configured application feature for the application instance at the client device and for the additional application instance at the additional client device in response to the detection.

12. The system of claim 9, wherein at least one setting of the one or more settings pertaining to the application feature is associated with an application resource provided by another application of the platform or another platform.

13. The system of claim 9, wherein each element of the electronic document is mapped to one or more operations that, when executed, enable at least a portion of the application feature according to at least one setting pertaining to the application feature, and wherein configuring the application feature for the application instance based on the electronic document and the obtained configuration data comprises:
generating a configuration file for the application feature based on the one or more operations and the obtained configuration data; and
providing the generated configuration file for execution.

14. The system of claim 13, wherein the one or more operations are included in a source code file associated with the application feature, the source code file comprising one or more placeholder values that reference configuration data items, and wherein generating the configuration file for the application feature based on the one or more operations and the obtained configuration data comprises:
obtaining a copy of the source code file including the one or more operations and the one or more placeholder values;
modifying the copy of the source code file to replace at least one of the one or more placeholder values with a configuration data item of the obtained configuration data.

15. The system of claim 9, wherein the client device is associated with an organization and the application instance is running using one or more additional client devices associated with the organization, and wherein the operations further comprise:
providing one or more additional users associated with the one or more additional client devices with access to the configured application feature for the application instance via the one or more additional client devices.

16. A non-transitory computer readable storage medium comprising instructions for a server that, when executed by a processing device, cause the processing device to perform operations comprising:
receiving a request from a client device of a user of a platform for configuring an application feature, of a plurality of application features, for an instance of an application provided by the platform;
identifying, from a plurality of electronic documents, an electronic document associated with the application feature of the request, wherein each of the plurality of electronic documents is associated with a respective application feature of the plurality of application features, and wherein each of the plurality of electronic documents comprises elements that enable users to configure settings pertaining to a respective application feature;
providing the electronic document for presentation to the user;
obtaining configuration data associated with one or more settings pertaining to the application feature based on a user interaction with one or more elements of the electronic document;
configuring the application feature for the application instance based on the electronic document and the obtained configuration data; and
providing the user with access to the configured application feature for the application instance via the client device, in accordance with the request.

17. The non-transitory computer readable storage medium of claim 16, wherein the operations further comprise:
responsive to an additional request from an additional client device associated with an additional user of the platform for configuring the application feature for an additional application instance associated with the additional user, configuring the application feature for the additional application instance based on the electronic document and additional configuration data provided by the additional user; and
providing the additional user with access to the configured application feature for the additional application instance via the additional client device.

18. The non-transitory computer readable storage medium of claim 17, wherein the operations further comprise:
detecting an update to the application feature; and
updating the configured application feature for the application instance at the client device and for the additional application instance at the additional client device in response to the detection.

19. The non-transitory computer readable storage medium of claim 16, wherein at least one setting of the one or more settings pertaining to the application feature is associated with an application resource provided by another application of the platform or another platform.

20. The non-transitory computer readable storage medium of claim 16, wherein each element of the electronic document is mapped to one or more operations that, when executed, enable at least a portion of the application feature according to at least one setting pertaining to the application feature, and wherein configuring the application feature for the application instance based on the electronic document and the obtained configuration data comprises:
generating a configuration file for the application feature based on the one or more operations and the obtained configuration data; and
providing the generated configuration file for execution.
